(19) United States
(12) Patent Application Publication
(10) Pub. No.: US 2014/0137572 A1
(43) Pub. Date: May 22, 2014

(54) Natural Gas Vehicle Vented Gas Capture System

(71) Applicant: CATERPILLAR INC., Peoria, IL (US)

(72) Inventor: Joshua W. Steffen, El Paso, IL (US)

(73) Assignee: CATERPILLAR INC., Peoria, IL (US)

(21) Appl. No.: 13/680,333

(22) Filed: Nov. 19, 2012

(51) Int. Cl. F17C 7/04

(52) U.S. Cl. CPC F17C 7/04
USPC 62/48.1

(57) ABSTRACT

A natural gas fuel system is provided. The system includes a vent gas recapture tank, a liquid natural gas (LNG) storage tank operably connected to the vent gas recapture tank, and a pressure control regulator operably connected to the vent gas recapture tank and the LNG storage tank. Vent gas is released from at least one point on the fuel system and stored in the vent gas recapture tank when certain conditions are met.

### TECHNICAL FIELD

The present disclosure relates generally to a natural gas fuel system for vehicles and more particularly, to a system and method of capturing vented gas from the fuel system in a low pressure storage vessel.

### BACKGROUND

Natural gas is one of the least-polluting fuels known. Moreover, the cost of natural gas makes it a cost effective alternative to other fuels due to its easy access and long term availability. Natural gas is commonly used in two different forms, compressed natural gas (CNG) and liquefied natural gas (LNG).

The use of compressed natural gas (CNG) as a fuel for motor vehicles has been known for many years and has become increasingly popular in many areas of the world especially as gasoline prices rise. One obstacle to the use of compressed natural gas vehicles is that compressed natural gas vehicles require a greater amount of space for fuel storage than conventional gasoline powered vehicles. Since it is a compressed gas, rather than a liquid like gasoline, CNG takes up more space for each gasoline gallon equivalent. Therefore, the tanks used to store the CNG usually take up additional space in a vehicle which runs on CNG.

Natural gas, however, can be liquefied as LNG and stored in a specially designed insulated cryogenic tank. The LNG can then be heated to CNG on board the vehicle and the CNG can be used to fuel the engine.

One major drawback is that vehicles using natural gas powered engines and liquid natural gas storage must vent as a result of the overall fuel transfer and fuel control process. For example, the fuel control process may necessitate releasing compressed natural gas to relieve the pressure from the pressure control regulator and avoid over-pressurization of the fuel rail which supplies compressed natural gas to the engine. The engine is used with a pressure control regulator, which opens or closes to adjust the pressure of the gas in the fuel rail based on the engine demand for fuel. There are times, however, when the regulator must vent to relieve pressure based on a sudden change in the engine load. This happens when there is a sudden change in the engine load and the regulator cannot respond quickly enough and therefore the regulator will vent a portion of gas to maintain the required pressure in the fuel rail and avoid over pressurization of the engine.

Furthermore, the fuel tanks used to hold LNG inherently experience heat leak to some extent. Heat leak is caused from heat leaking through or entering the fuel tank. The heat source may be ambient heat or it may be heat generated from various pieces of process equipment, such as pumps, used in the fuel system. The heat in any event dramatically affects the pressure and temperature of the LNG in the fuel tank and causes some of the liquid LNG to evaporate and increase the pressure in the tank. This pressure in the fuel tank eventually must be relieved.

Venting natural gas to the atmosphere, however, is an issue due to greenhouse gas concerns and potential regulations limiting methane discharge to atmosphere as well as the loss of fuel.

Known systems for capturing vented natural gas provide a system that includes a main tank and an auxiliary tank that is in fluid communication, and receives vapor and expanding fluid as the cold fluid in the main tank warms thereby avoiding over pressurization of the system. (U.S. Pat. No. 5,685,159) These systems, however, do not provide a system and a method of capturing vent gas at other points in the fuel system.

### SUMMARY

In accordance with some embodiments of the present disclosure, a natural gas fuel system is provided. The natural gas fuel system may include a vent gas recapture tank, a liquid natural gas storage (LNG) tank operably connected to the vent gas recapture tank, and a pressure control regulator operably connected to the vent gas recapture tank and the LNG storage tank. The vent gas may be released from at least one point on the fuel system and stored in the vent gas recapture tank when certain conditions are met.

In another aspect of the present disclosure, the natural gas fuel system includes a liquid natural gas (LNG) storage tank and a pressure control regulator operably connected to the LNG storage tank. The vent gas is released from the pressure control regulator and stored in the LNG storage tank when certain conditions are met.

In yet another aspect of the present disclosure, a method of releasing vent gas from a natural gas fuel system is provided. The method includes releasing vent gas from at least one point in the fuel system when certain conditions are met, and storing the vent gas in the LNG storage tank.

In yet another aspect of the present disclosure, a method of releasing vent gas from a natural gas fuel system is provided. The method includes releasing vent gas from at least one point in the fuel system when certain conditions are met, and storing the vent gas in the vent gas recapture tank.

### BRIEF DESCRIPTION OF THE DRAWINGS

FIG. 1 is a schematic illustration of a natural gas fuel system in accordance with the present disclosure with the vent gas recapture tank.

FIG. 2 is a schematic illustration of a natural gas fuel system in accordance with the present disclosure without the vent gas recapture tank.

### DETAILED DESCRIPTION

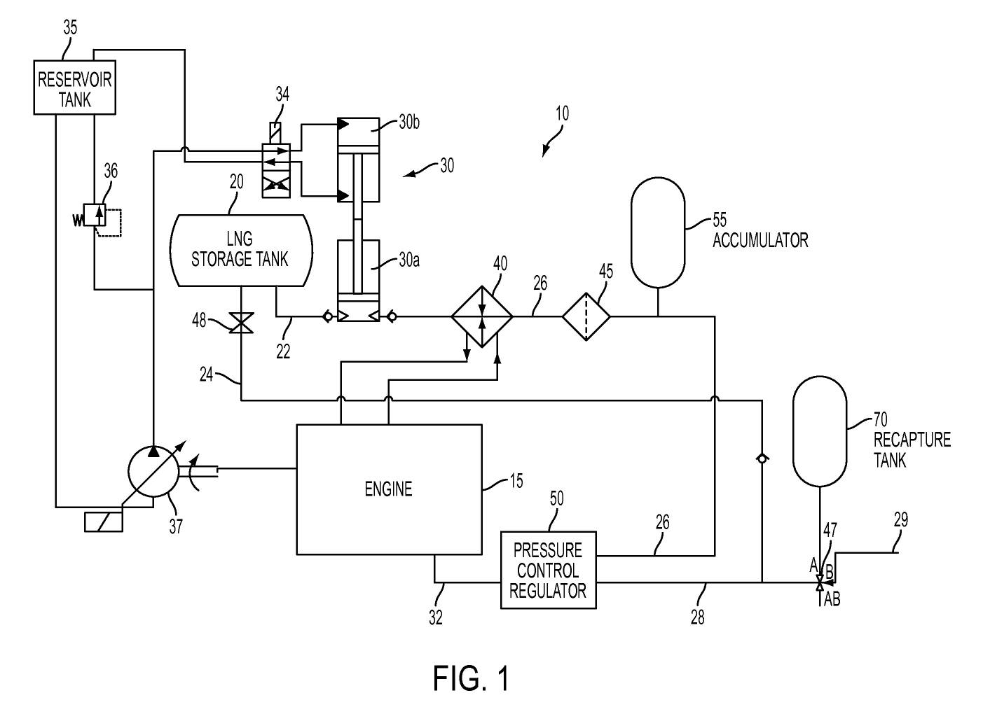

Referring to FIG. 1, a schematic illustration of a natural gas fuel system in accordance with the present disclosure is shown. The natural gas fuel system 10 includes a liquefied natural gas (LNG) storage tank 20, LNG pump 30, a primary heater 40, a pressure control regulator 50, an engine 15, a low pressure vent gas recapture tank 70, and an offloading valve 47. The LNG storage tank 20 is operably connected to the recapture tank 70. The pressure control regulator 50 is operably connected to the recapture tank 70 and the LNG storage tank 20.

Natural gas is maintained in a liquid state in LNG storage tank 20. The natural gas fuel system 10 may be provided with a LNG pump 30 to pressurize and to transfer the liquid natural gas from the LNG storage tank 20 to the primary heater 40. The primary heater 40 is used to heat the liquid natural gas such that it becomes warm compressed natural gas (CNG) and is ready to be used as fuel for the engine 15. The pressure control regulator 50 is used to adjust the pressure of the compressed natural gas before it enters the engine 15.

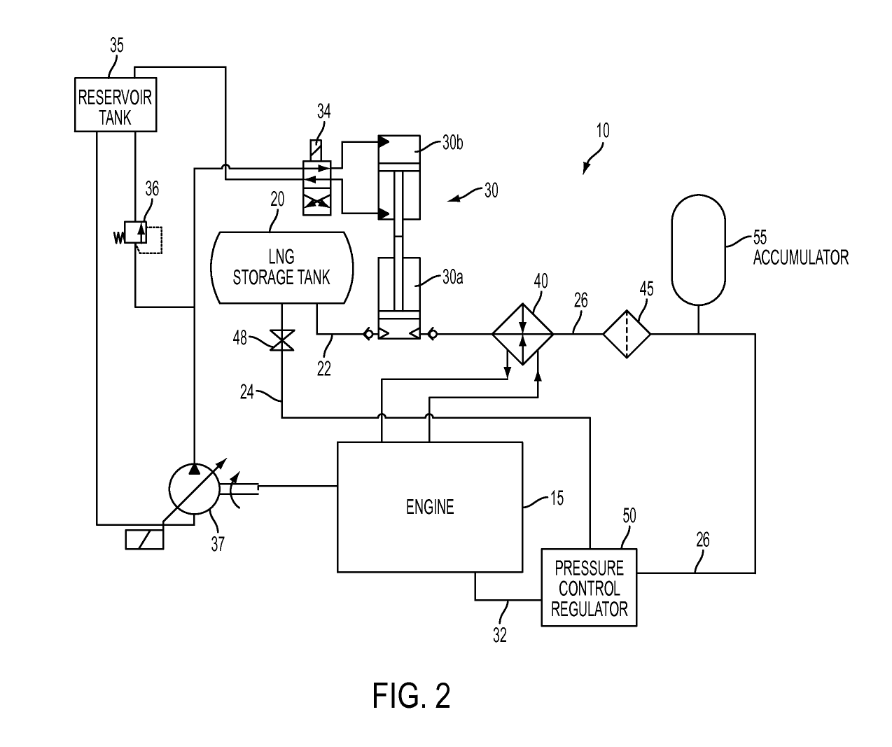

In one embodiment according the present disclosure, the LNG pump 30 is hydraulically driven and is composed of a LNG pumping element 30a and pump actuator cylinder 30b. A hydraulic circuit, shown in FIGS. 1 and 2, may be used to drive the LNG pump 30. The hydraulic circuit includes a directional control valve 34, a reservoir tank 35, a pressure control valve 36, and a pump 37, which may be coupled to the engine 15.

The pump 37 draws hydraulic fluid from reservoir tank 35, pressurizes and supplies the pressurized hydraulic fluid to directional control valve 34, which supplies the pressurized hydraulic fluid to pump actuator cylinder 30b. Directional control valve 34 may be electronically, hydraulically or mechanically controlled to alternatively provide pressurized hydraulic fluid to each end of pump actuator cylinder 30b, which drives LNG pumping element 30a accordingly. A pressure control valve 36, coupled to the reservoir tank 35, may be provided on the high pressure side of the hydraulic circuit, between the pump 37 and the directional control valve 34.

The LNG storage tank 20 stores liquefied natural gas for a natural gas fuel system 10. The LNG storage tank 20 is an insulated cryogenic tank designed to hold liquefied natural gas at a very low temperature to maintain its liquefied form. For example, LNG is usually stored in the LNG storage tank 20 at -260 F and at 40 psig.

The LNG storage tank 20 has the capacity to hold a certain volume of LNG and also has a maximum operating pressure. The maximum operating pressure is the maximum pressure that the LNG storage tank 20 can safely withstand without damage. The maximum operating pressure of the LNG storage tank 20 may be a function of the capacity of the LNG storage tank 20 as well as the operating conditions of the LNG storage tank 20. In one embodiment, the maximum operating pressure of the LNG storage tank 20 may be at least 100 psig but may be as high as 230 psig.

The pressure of the LNG storage tank 20 should not exceed the maximum operating pressure. The LNG storage tank 20 will operate at pressures that are below the maximum operating pressure of the LNG storage tank 20. For example, the LNG storage tank 20 used in the natural gas fuel system 10 may operate at pressures between atmospheric pressure and 150 psi.

When the temperature of the LNG in the LNG storage tank 20 rises, a portion of the LNG will evaporate and the pressure in the LNG storage tank 20 will increase. The LNG storage tank 20 is designed to withstand some of these pressure increases from the evaporated liquid. However, when the pressure in the LNG storage tank 20 becomes too high as a result of the evaporated LNG or vapor, the vapor must be vented or released from the LNG storage tank 20 to lower the pressure in the LNG storage tank 20. The vapor must be vented when the pressure of the LNG storage tank 20 is equal to or exceeds the pressure rating or the maximum operating pressure of the LNG storage tank 20. The vapor released from the natural gas fuel system 10 may be referred to as vent gas in this disclosure.

A pressure relief valve 48 may be coupled to the LNG storage tank 20 as shown in FIG. 1. The pressure relief valve 48 is designed to control the pressure in the LNG storage tank 20. For example, when the pressure of the LNG storage tank 20 exceeds its pressure rating, the pressure relief valve 48 will open and divert gas to the recapture tank 70. The pressure relief valve 48 is set to open at a set pressure which may be the pressure rating of the LNG storage tank 20 or some other predetermined maximum operating pressure to protect the LNG storage tank 20. When the set pressure is exceeded, the pressure relief valve 48 is forced open and gas is released to the recapture tank 70. As the gas is released, the pressure inside the LNG storage tank 20 will drop. Once the LNG storage tank 20 reaches a pressure that is within the operating range for the LNG storage tank 20 or a pressure that is less than the pressure rating or the maximum operating pressure, the pressure relief valve 48 will close.

The LNG storage tank 20 has a first outlet line 22 and a second outlet line 24 as shown in FIG. 1. The first outlet line 22 is for LNG, which flows through the LNG pump 30 and the primary heater 40. LNG enters the primary heater 40 and leaves as high pressure warm compressed natural gas (CNG).

An LNG pump 30 is used to transfer LNG through a high pressure gas filter 45 and primary heater 40 for expansion into a gas that is afterwards maintained in an accumulator 55. The accumulator 55 is simply a container holding the high pressure warm CNG before the gas enters the pressure control regulator 50 and engine 15. The natural gas fuel system 10 of the present disclosure does not require an accumulator 55. The accumulator 55 is useful for accommodating volumetric variations resulting from changes in pressure and volumetric flow rate. The accumulator 55 is also useful for providing a buffer for the engine 15 which will help the engine 15 to respond to varying load conditions.

The second outlet line 24 of the LNG storage tank 20 is for low pressure vent gas. As explained above, the temperature of the LNG storage tank 20 must be kept very low in order to keep the LNG liquefied. The temperature of the LNG storage tank 20, however, inevitably raises evaporating some of the LNG and creating vapor in the LNG storage tank 20. As the amount of evaporated LNG or vapor increases in the LNG storage tank 20, the pressure increases, necessitating the release of at least some of this vapor from the LNG storage tank 20. The vapor released from the LNG storage tank 20 is referred to as vent gas. Therefore, the second outlet line 24 of the LNG storage tank 20 will open and allow low pressure vent gas to be released from the LNG storage tank 20. The low pressure vent gas released from the LNG storage tank 20 using the second outlet line 24 of the LNG storage tank 20 is stored in the recapture tank 70 in accordance with some embodiments of the present disclosure. The recapture tank 70 may be plumbed to any place on the natural gas fuel system 10 where pressure may be relieved by releasing natural gas. The recapture tank 70, in some embodiments of the present disclosure, contains vent gas from the LNG storage tank 20 as well as vent gas from the pressure control regulator 50 as explained further below.

The recapture tank 70 may be carried on board a vehicle and then the gas may be transferred from the recapture tank 70 when the vehicle is stopped for use in other natural gas applications. An offloading valve 47 may be used to transfer the vent gas from the recapture tank 70 to a storage vessel once the vehicle has stopped to refuel. In some embodiments, the vent gas that discharged from the recapture tank 70 may be re-liquefied for use in the vehicle. In either event, vent gas is discharged from the recapture tank 70 such that the recapture tank 70 is empty and can be used again.

The storage vessel (not shown) used to hold the vent gas transferred from the recapture tank 70 must be at a pressure that is lower than the pressure of the recapture tank 70 in order to discharge the vent gas from the recapture tank 70. Therefore, the storage vessel used is not a conventional tank used to hold CNG at a fuel station because the CNG would be at a higher pressure than the vent gas. The vent gas contained in the storage vessel could later be pressurized and used as CNG to fuel other vehicles. The vent gas contained in the storage vessel may also be re-liquefied for use in vehicles. The storage vessel also must be able to connect to the connection line 29. The connection line 29 is an outlet line that is connected to the offloading valve 47 and used to transfer the vent gas from the recapture tank 70 to the storage vessel.

The recapture tank 70 must be held at a pressure below the lowest pressure source that could vent to it. In some embodiments, this pressure is at the pressure relief valve 48 which is coupled to the outlet of the LNG storage tank 20. For example, in some embodiments, the pressure relief valve 48 is set to open at approximately 230 psi estimated. Therefore, the recapture tank 70 must be designed to never see pressures above 230 psi or the value of the pressure of the pressure relief valve 48 at the outlet of the LNG storage tank 20.

The recapture tank 70 may be sized similar to the accumulator 55 and may be smaller than the LNG storage tank 20. The recapture tank 70 may be cylindrical in shape. The recapture tank 70 does not need to be insulated. It may be held at a pressure greater than atmospheric pressure but is at a pressure lower than anywhere else on the fuel system. In some embodiments of the present disclosure, the recapture tank 70 may operate between atmospheric and 100 psi.

The natural gas fuel system 10 includes a pressure control regulator 50, which is used to maintain the correct pressure in the fuel line 27 supplying the engine 15. The pressure control regulator 50 is able to adjust the flow of CNG higher or lower in response to the requirements of the engine 15, which change based on whether the vehicle is stationary, moving, or accelerated. These conditions of the vehicle will cause the engine 15 to require less fuel or more fuel. Depending on the engine's fuel requirements, the pressure control regulator 50 will adjust its position to vary the amount of flow through the pressure control regulator 50 to maintain the desired pressure of the fuel line 27.

For example, if the vehicle is stationary, less fuel may be needed during this time. Therefore, the pressure control regulator 50 may close and decrease the amount of flow through to the fuel line 27 to maintain the desired pressure in the fuel line 27. If the vehicle is moving or suddenly accelerates, the pressure control regulator 50 may open to increase the amount of flow to the fuel line to maintain pressure in the fuel line 27 and deliver an appropriate amount of CNG to the engine 15.

As shown in FIG. 1, the pressure control regulator 50 is operably connected to the recapture tank 70 and the LNG storage tank 20. The pressure control regulator 50 has an inlet line 26 which contains high pressure warm CNG line that has exited the primary heater 40 and feeds directly into the pressure control regulator 50. This high pressure warm CNG enters the pressure control regulator 50 through the inlet line 26 where the pressure control regulator 50 adjusts the pressure of the CNG to meet the requirements of the engine 15 by opening or closing. The function of the pressure control regulator 50 is to ensure that the pressure of the CNG exiting the pressure control regulator 50 at the fuel line 27 and entering the engine 15 is maintained at a certain pressure to meet the requirements of the engine 15.

The pressure control regulator 50 has a fuel line 27 and a vent gas outlet line 28. The fuel line 27 contains warm CNG at a certain pressure, which is supplied to the engine 15 as fuel. The pressure of the fuel line 27 will change in response to the requirements of the engine 15, which is based on the condition of the vehicle.

The vent gas outlet line 28 of the pressure control regulator 50 releases CNG as low pressure vent gas. The CNG that is released from the pressure control regulator 50 is referred to as vent gas in the present disclosure. To maintain the correct pressure in the fuel line 27, the pressure control regulator 50 needs to release vent gas to relieve pressure in the pressure control regulator 50 when certain conditions are met. For example, if the pressure of the inlet line 26 to the pressure control regulator 50 is too high to maintain the correct pressure in fuel line 27 to the engine 15, then the pressure control regulator 50 will release gas through the vent gas outlet line 28. This particular instance may arise if the vehicle's demand for fuel suddenly changes, i.e., the vehicle was accelerating and then stops. The pressure control regulator 50 may not be able to respond quickly enough to relieve the pressure in the fuel line 27 in this instance and therefore the pressure control regulator 50 will release gas from the vent gas outlet line 28. The vent gas released from the pressure control regulator 50 using the vent gas outlet line 28 of the pressure control regulator 50 is stored in the recapture tank 70 in accordance with some embodiments of the present disclosure.

Alternatively, in some embodiments of the present disclosure, vent gas is released from the pressure control regulator 50 through the vent gas outlet line 28 for the pressure control regulator 50 and is stored in the LNG storage tank 20. As shown in FIG. 2, the second outlet line 24 from the pressure control regulator 50 feeds into the LNG storage tank 20 instead of the recapture tank 70.

Because the vent gas is stored in the LNG storage tank 20, a recapture tank 70 is not required in this embodiment. Although this method, if used alone, only releases gas from one point on the fuel system (i.e., the pressure control regulator 50), it may be a less expensive option when releasing vent gas from the pressure control regulator 50 because it does not require installing a recapture tank 70 to store the vent gas from the pressure control regulator 50. Furthermore, it has the advantage that it requires only a modest change to a pre-existing natural gas fuel system, i.e., installing a second outlet line 24 from the pressure control regulator 50 to the LNG storage tank 20.

Storing vent gas released from the pressure control regulator 50 to the LNG storage tank 20, however, will cause the pressure as well as the temperature in the LNG storage tank 20 to increase. When the pressure of the LNG storage tank 20 reaches its maximum operating pressure, gas from the LNG storage tank 20 must be released. Therefore, the LNG storage tank 20 may become over pressurized more quickly than if the recapture tank 70 was used to store the vent gas.

### Industrial Applicability

The natural gas fuel system 10 of the present disclosure finds general applicability to any engine 15 that utilizes natural gas as a fuel. The natural gas fuel system 10 of the present disclosure also finds general applicability to any type of motor vehicle that can be powered using natural gas, such as a car, truck, bus or any light or heavy duty vehicles.

The natural gas fuel system 10 of the present disclosure allows gas to be vented from multiple locations in the fuel system, including the LNG storage tank 20 and pressure control regulator 50. The natural gas fuel system 10 also allows the gas that is vented as a result of temperature and pressure changes to be stored in a recapture tank 70 and carried on board the vehicle. Using a recapture tank 70 to store the vent gas instead of releasing the vent gas to the atmosphere is particularly advantageous due to the greenhouse gas concerns and potential regulations limiting methane discharge to atmosphere. Furthermore, storing the vent gas in a recapture tank 70 rather than releasing it to the atmosphere also has the advantage that the natural gas fuel system 10 is not losing any natural gas and is thus a more efficient fuel system. For example, the vent gas from the recapture tank 70 can be transferred to a storage vessel and re-liquefied as LNG or pressurized as CNG and used as fuel for the vehicle again.

The natural gas fuel system 10 of the present disclosure may also release vent gas from the pressure control regulator 50 and store the vent gas in the LNG storage tank 20 such that a recapture tank 70 is not required. This method of venting gas and the fuel system has the advantage that it makes use of the pre-existing process equipment does not require installing an additional tank.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A natural gas fuel system, comprising:
a vent gas recapture tank;
a liquid natural gas (LNG) storage tank operably connected to the vent gas recapture tank; and
a pressure control regulator operably connected to the vent gas recapture tank and the LNG storage tank,
wherein vent gas is released from at least one point on the fuel system and stored in the vent gas recapture tank when certain conditions are met.

2. The system of claim 1, wherein vent gas is released from the pressure control regulator.

3. The system of claim 1, wherein vent gas is released from the LNG storage tank.

4. The system of claim 2, wherein vent gas is released from the LNG storage tank.

5. The system of claim 1, further comprising an engine, operably connected to the pressure control regulator, wherein the pressure control regulator supplies the engine with gas within a certain pressure range based on the requirements of the engine.

6. The system of claim 5, wherein the pressure range of the gas supplied to the engine is 20-60 MPa.

7. The system of claim 6, wherein vent gas is released from the pressure control regulator when the outlet pressure of the pressure control regulator exceeds the pressure required by the engine.

8. The system of claim 5, wherein vent gas is released from the pressure control regulator when the outlet pressure of the pressure control regulator exceeds the pressure required by the engine.

9. The system of claim 1, wherein vent gas is released from the LNG storage tank when the pressure of the LNG storage tank exceeds the maximum operating pressure of the LNG storage tank.

10. The system of claim 1, wherein vent gas is released from the LNG storage tank when the pressure of the LNG storage tank exceeds 150 psi.

11. The system of claim 1, wherein vent gas is released from the LNG storage tank when the pressure of the LNG storage tank exceeds 230 psi.

12. The system of claim 1, wherein the vent gas recapture tank is at a pressure lower than the pressure of the LNG storage tank.

13. The system of claim 1, wherein the vent gas stored in the recapture tank is offloaded for use in other natural gas applications.

14. The system of claim 1, wherein the vent gas stored in the recapture tank is re-liquefied for use in the vehicle.

15. A natural gas fuel system, comprising:
a liquid natural gas (LNG) storage tank; and
a pressure control regulator operably connected to the LNG storage tank,
wherein vent gas is released from the pressure control regulator and stored in the LNG storage tank when certain conditions are met.

16. A method of releasing vent gas from a natural gas fuel system having a liquid natural gas (LNG) storage tank and a pressure control regulator operably connected to the LNG storage tank, the method comprising:
releasing vent gas from at least one point in the fuel system when certain conditions are met; and
storing the vent gas in the LNG storage tank.

17. A method of releasing vent gas from a natural gas fuel system having a vent gas recapture tank, a liquid natural gas (LNG) storage tank operably connected to the vent gas recapture tank and a pressure control regulator operably connected to the vent gas recapture tank and the LNG storage tank, the method comprising:
releasing vent gas from at least one point in the fuel system when certain conditions are met; and
storing the vent gas in the vent gas recapture tank.

18. The method of claim 17, wherein releasing vent gas further comprises releasing vent gas from the pressure control regulator.

19. The method of claim 17, wherein releasing vent gas further comprises releasing vent gas from the LNG storage tank.

20. The method of claim 18, wherein releasing vent gas further comprises releasing vent gas from the LNG storage tank.
